(19) United States
(12) Patent Application Publication
(10) Pub. No.: US 2024/0340488 A1
(43) Pub. Date: Oct. 10, 2024

(54) DYNAMIC MODIFICATION OF SUPPLEMENTAL CONTENT AUDIENCE

(71) Applicant: Comcast Cable Communications, LLC, Philadelphia, PA (US)

(72) Inventor: Robert BRESS, New Providence, NJ (US)

(21) Appl. No.: 18/297,993

(22) Filed: Apr. 10, 2023

(51) Int. Cl. H04N 21/431; G06Q 30/0251

(52) U.S. Cl. CPC H04N 21/4316; G06Q 30/0255; G06Q 30/0261; G06Q 30/0271

(57) ABSTRACT

Methods and systems for dynamic modification of an audience are disclosed. A portion of an audience to which a supplemental content item was output during output of a first content item may be determined. A modified audience may be determined based on at least one characteristic associated with the portion of the audience to which the supplemental content item was output during output of the first content item. Output of the supplemental content item may be caused during output of a second content item. The second content item may be determined based on at least one characteristic associated with the modified audience.

### BACKGROUND

Content providers may make supplemental content available for output by one or more user devices. The supplemental content may comprise one or more advertisements for products or services offered by third parties or by the content providers themselves. The supplemental content may be output during the presentation of one or more other types of content, including movies and television shows, such that the supplemental content may be viewed by one or more audience members. It may be desirable to improve the likelihood that the supplemental content will be viewed by one or more target audience members that are most likely to be interested in viewing the supplemental content.

### SUMMARY

Systems, methods, and devices relating to household classification are described herein. An audience for a supplemental content item (e.g., an advertisement) may be identified. The audience may be exposed to the supplemental content item, such as during output of another type of content (e.g., a movie or television show). A portion of the audience that is exposed to the supplemental content item may view and/or interact with the supplemental content item. The portion of the audience that views and/or interacts with the supplemental content item may be more likely to be interested in the supplemental content item than the portion of the audience that does not view and/or interact with the supplemental content item. The audience may be modified so that a greater percentage of the audience resembles (e.g., shares at least one characteristic with) the portion of the audience that viewed and/or interacted with the supplemental content item. Modifying the audience so that a greater percentage of the audience resembles the portion of the audience that viewed and/or interacted with the supplemental content item may increase the quantity of potential customers exposed to the supplemental content item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF DRAWINGS

The accompanying drawings, which are incorporated in and constitute a part of this specification, illustrate embodiments and together with the description, serve to explain the principles of the systems, methods, and devices:

FIG. 1 is an example system.

FIG. 2 is an example user device.

FIG. 3 is example data.

FIG. 4 is example data.

FIG. 5 is example data.

FIG. 6 is an example method.

FIG. 7 is an example method.

FIG. 8 is an example method.

FIG. 9 is an example computing system.

Aspects of the disclosure will now be described in detail with reference to the drawings, wherein like reference numbers refer to like elements throughout, unless specified otherwise.

### DETAILED DESCRIPTION

Content providers may make content, such as television shows and movies, available for output (e.g., playback) to one or more audience members (e.g., viewers). The content provider may additionally or alternatively cause output of supplemental content to the audience member(s). For example, a content provider may cause output of supplemental content to the one or more viewers during output of a television show or a movie. The supplemental content may comprise one or more advertisements, such as advertisements for products or services offered by third parties, upcoming television and movie releases, or products or services offered by the content providers themselves.

Output of a supplemental content item may be optimized by outputting the supplemental content item to an audience associated with the supplemental content item. The audience may comprise a target audience. The target audience may comprise one or more audience members most likely to be interested in that supplemental content item. For example, a supplemental content item relating to adult men's apparel may most likely be of interest to a demographic of males between the ages of 18-60. Thus, the target audience associated with a supplemental content item relating to adult men's apparel may comprise males between the ages of 18-60. Outputting a supplemental content item to the audience associated with the supplemental content item may maximize the number of desired exposures to the supplemental content item.

However, the audience associated with a supplemental content item may be too broadly defined. If the audience is too broadly defined, the audience may comprise a significant quantity of audience members that are not actually interested in the supplemental content item. For example, as described above, the audience associated with a supplemental content item relating to adult men's apparel may comprise males between the ages of 18-60. However, males between the ages of 40-60 may not actually be interested in viewing supplemental content items relating to adult men's apparel. If the audience comprises a significant quantity of audience members that are not actually interested in the supplemental content item, the supplemental content item may be shown to a large quantity of individuals who are not potential customers. Causing output of the supplemental content item to a large quantity of individuals who are not potential customers may be an inefficient use of money and time.

It may therefore be desirable for the audience associated with a supplemental content item to be dynamically modified (e.g., adjusted, refined) throughout the course of the advertising campaign. Described herein are techniques for dynamically modifying an audience, such as a target audience, associated with a supplemental content item throughout the course of an advertising campaign. The audience associated with a supplemental content item may be dynamically modified based on information gathered during the advertising campaign. The information may indicate one or more members of the audience that interacted with (e.g., viewed and/or responded to) the supplemental content item during output of the supplemental content item. The audience may be modified so that a greater percentage of the audience resembles (e.g., shares at least one characteristic with) the member(s) of the audience that interacted with the supplemental content item. This process of gathering information indicating audience members that interacted with the supplemental content item and modifying the audience based on the information may be repeated any quantity of times. For example, this process of gathering information indicating audience members that interacted with the supplemental content item and modifying the audience based on the information may be repeated as many times as possible before the end of the advertising campaign.

Dynamically modifying the audience for a supplemental content item throughout the course of the advertising campaign may ensure that the supplemental content item is viewed by those individuals most likely to be interested in the supplemental content item. Ensuring that the supplemental content item is viewed by those individuals most likely to be interested in the supplemental content item may maximize the quantity of potential customers exposed to the supplemental content item—thus maximizing the supplemental content provider's return on advertising investment.

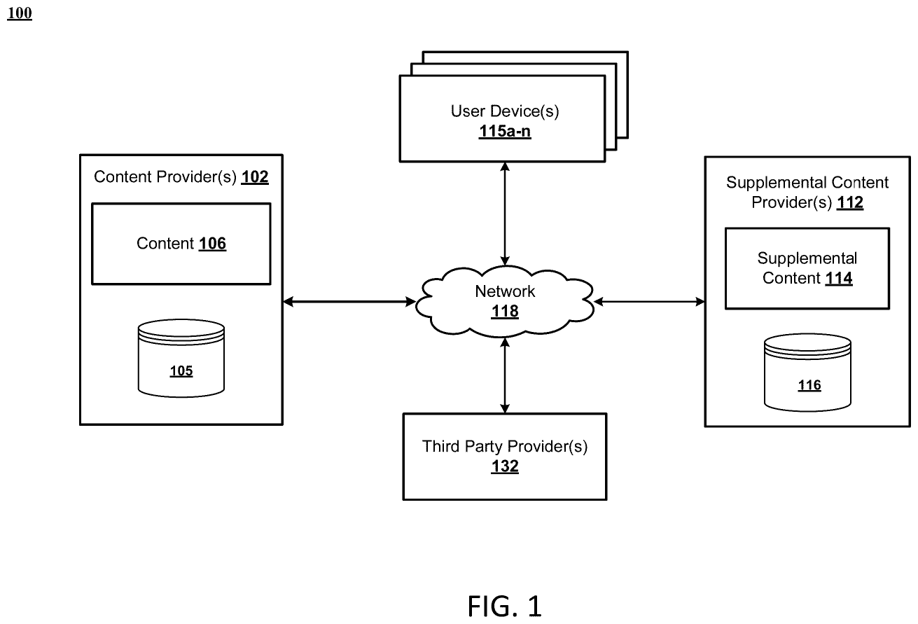

FIG. 1 shows an example network in which the present systems, methods, and devices may be implemented. As shown in FIG. 1, a network 100 may comprise at least one content provider(s) 102, at least one supplemental content provider(s) 112, a plurality of user devices 115a-n, and at least one third-party provider 132. The at least one content provider(s) 102, the at least one supplemental content provider(s) 112, the plurality of user devices 115a-n, and the at least one third-party provider 132 may be in communication via a network 118.

The content provider(s) 102 may be configured to distribute (e.g., provide, transmit) content 106 to a plurality of user devices 115a-n. The content 106 transmitted by the content provider(s) 102 may include one or more content items. The content 106 may be transmitted to the plurality of user devices 115a-n using any suitable protocol.

A content item may comprise, as an example, a video program. A video program may refer generally to any video content produced for viewer consumption. A video program may comprise video content produced for broadcast via over-the-air radio, cable, satellite, or the internet. A video program may comprise video content produced for digital video streaming or video-on-demand. A video program may comprise a television show or program. A video program series may comprise two or more associated video programs. For example, a video program series may include an episodic or serial television series. As another example, a video program series may include a documentary series, such as a nature documentary series. As yet another example, a video program series may include a regularly scheduled video program series, such as a nightly news program.

Non-limiting examples of a content provider(s) 102 include a television broadcast network, a cable television network, a satellite television network, an internet service provider (ISP), a computing device advertising network, a media distribution network, a cloud computing network, a local area network (LAN), a wide area network (WAN), or any combination thereof.

The content 106 transmitted by the content provider(s) 102 may include supplemental content. Supplemental content may generally include any type of data capable of being received and consumed by a recipient. For example, supplemental content may include advertising, entertainment programs, informational programs, messages, video, audio, graphical, and/or animated content. The supplemental content may include, for example, one or more addressable (e.g., targeted) advertisements.

The supplemental content may be inserted into the content 106 transmitted by the content provider(s) 102. For example, the supplemental content may be inserted into a supplemental content insertion opportunity (e.g., avail) in the content 106. Such supplemental content insertion opportunities may be indicated by one or more supplemental content insertion markers inserted into the stream of content. The supplemental content insertion markers may be timed metadata inserted into a stream of content that signal a supplemental content insertion opportunity in a content stream. The supplemental content insertion markers may be, for example, SCTE 35 markers in accordance with the American National Standards Institute (ANSI)/SCTE 35 standard. Additionally, or alternatively, the supplemental content insertion markers may be identified in XML with time codes associated with avail start and end times, and/or any other means of defining supplemental content insertion opportunity times.

The content provider(s) 102 may be configured to operate across physical device platforms and networks simultaneously. For example, the content 106 may be delivered by the content provider(s) 102 (such as via one or more local content systems) to the plurality of user device 115a-n using standard network communication protocols (for instance, Ethernet or Wi-Fi) over an ISP network, standard telecommunication protocols (for instance, third Generation (3G), fourth Generation (4G), long-term evolution (LTE), or the like), and/or through a LAN, WAN and/or ISP network.

The content provider(s) 102 may comprise at least one database, such as the database(s) 105. The database(s) 105 may store data indicative of information associated with the audience of the content provider(s) 102. The audience of the content provider(s) 102 may comprise the households and/or user devices (e.g., the plurality of user devices 115a-n) to which the content provider(s) 102 distributes content.

The database(s) 105 may store content viewership information associated with the audience. Content viewership information associated with the audience may indicate, for example, how much content and what type(s) of content each of the plurality of user devices 115a-n consumes. For example, the content viewership information associated with the audience may indicate whether each of the plurality of user devices 115a-n consumes linear content, non-linear content, content associated with a particular genre, and/or a supplemental content item (such as an advertisement that is part of an ad campaign). Linear content may include a live television program that airs on a particular channel at a scheduled time. Non-linear household content may include content distributed via broadband (e.g., internet), broadcast, and/or premium cable (e.g., pay-cable). The content viewership information associated with the audience may indicate how much of each type of content each of the plurality of user devices 115a-n consumes. For example, the database(s) 105 may store data indicative of a quantity of time (e.g., number of minutes, hours, etc.) that each of the plurality of user devices 115a-n has spent watching one or more of linear content, non-linear content, content associated with a particular genre, and/or a supplemental content item.

The database(s) 105 may store STB viewership information. The STB viewership information may indicate which content and how much content that each of the plurality of user devices 115a-n d has consumed via its STB. The database(s) 105 may additionally, or alternatively, store smart television data. The smart television data may indicate which content and how much content that each of the plurality of user devices 115a-n has consumed via its smart television. The database(s) 105 may store different content viewership data in addition to, or as an alternative to, the STB viewership information and the smart television data.

The database(s) 105 may store subscriber information associated with the audience. Subscriber information associated with the audience may include, for example, information about each of the plurality of user devices 115a-n that receives content from the content provider(s) 102, including what types of services (linear content, video-on-demand, etc.) each of the plurality of user devices 115a-n subscribes to. Other subscriber information may include general information and/or demographic information, such as names, gender, age/date of birth, ethnicity, address/geographic location, occupation, years of home ownership, household size, income, geographic location, family size, or media consumption habits, any/or any other information that the content provider(s) 102 collects from its audience or receives about its audience.

The supplemental content provider(s) 112 may be configured to distribute (e.g., provide, transmit) supplemental content 114 to the content provider(s) 102. The supplemental content 114 transmitted by the supplemental content provider(s) 112 may comprise one or more supplemental content items. The supplemental content 114 may be transmitted to the content provider(s) 102 and/or to the plurality of user devices 115a-n using any suitable protocol.

The content provider(s) 102 may receive the supplemental content 114. The content provider(s) 102 may forward (e.g., send) the received supplemental content 114 to the plurality of user devices 115a-n. The content provider(s) 102 may be configured to send the supplemental content 114 to the plurality of user devices 115a-n along with the content 106 in which the supplemental content 114 is to be inserted. The content provider(s) 102 may insert the supplemental content 114 into one or more supplemental content insertion opportunities in the content 106. The content provider(s) 102 may send the combination of the supplemental content 114 and the content 106 to the plurality of user devices 115a-n. The content provider(s) 102 may not insert the supplemental content 114 into one or more supplemental content insertion opportunities in the content 106. Instead, the content provider(s) 102 may send the supplemental content 114 and the content 106 to the plurality of user devices 115a-n, and the plurality of user devices 115a-n may insert the supplemental content 114 into one or more supplemental content insertion opportunities in the content 106.

The supplemental content provider(s) 112 may be configured to send insertion instructions to the content provider(s) 102. The insertion instructions may indicate a content item in which to insert a particular supplemental content item. The content item may be determined by the supplemental content provider(s) 112 based on one or more characteristics of a target audience associated with the supplemental content item. If the supplemental content provider(s) 112 sends insertion instructions to the content provider(s) 102, the content that the content provider(s) 102 sends to the plurality of user devices 115a-n along with the supplemental content item may be the content item indicated by the insertion instructions. If the supplemental content provider(s) 112 does not send insertion instructions to the content provider(s) 102, the content that the content provider(s) 102 sends to the plurality of user devices 115a-n along with the supplemental content item may a content item selected by the content provider(s) 102. The content item may be determined by the content provider(s) 102 based on one or more characteristics of the target audience associated with the supplemental content item.

The plurality of user devices 115a-n may be configured to receive the content 106 and/or the supplemental content 114 from the content provider(s) 102. The plurality of user devices 115a-n may comprise any one of numerous types of devices configured to effectuate content output and/or viewing. The plurality of user devices 115a-n may be configured to receive the content 106 and/or the supplemental content 114 and output the content 106 and/or the supplemental content 114 to a display device for consumer viewing.

Each of the plurality of user devices 115a-n may comprise a set-top box (STB), such as a cable STB, a digital video recorder (DVR) that receives and stores video content for later viewing, a television, a smart television, a personal computer (PC), a laptop computer, a mobile computing device, a smartphone, a tablet computing device, a home gateway, or the like. Each of the plurality of user devices 115a-n may combine any features or characteristics of the foregoing examples. For instance, a user device may include a cable STB with integrated DVR features.

A supplemental content item may be associated with an ad campaign. The ad campaign may be associated with a predetermined duration (e.g., 30 days, two months, three months, etc.) and/or the ad campaign may be associated with a predetermined quantity of exposures. If the ad campaign is associated with a predetermined duration, the ad campaign may be complete (e.g., terminate) based on the predetermined duration elapsing. If the ad campaign is associated with a predetermined quantity of exposures, the ad campaign may be complete when the predetermined quantity of viewers has been exposed to the supplemental content item.

The supplemental content provider(s) 112 may send the supplemental content item to the content provider(s) 102 for distribution to an initial (e.g., original) target audience. The initial target audience may comprise a subset of the plurality of user devices 115a-n. The subset of the plurality of user devices 115a-n may comprise a segment of the plurality of user devices 115a-n that are first to be exposed the supplemental content item during the ad campaign. The initial target audience associated with the supplemental content item may be defined, for example, before or at the beginning of the ad campaign. The subset of the plurality of user devices 115a-n may be associated with users that are most likely to be interested in the supplemental content item. The users that are most likely to be interested in the supplemental content item may comprise users determined to be likely potential customers of the product or service associated with the supplemental content item. For example, if the supplemental content item comprises an advertisement relating to adult men's apparel, the subset of the plurality of user devices 115a-n may be associated with users that are most likely to be purchase adult men's apparel.

The initial target audience associated with the supplemental content item may be determined by the content provider(s) 102. The content provider(s) 102 may determine the initial target audience based on data stored in the database(s) 105. As described above, the database(s) 105 may store content viewership information, STB viewership information, and/or subscriber information, such as demographic information, associated with each of the plurality of user devices 115a-n. The content provider(s) 102 may determine at least one characteristic associated with the supplemental content item. The at least one characteristic associated with the supplemental content item may indicate a product or service that is being advertised by the supplemental content item. The content provider(s) 102 may determine, based on the data stored in the database(s) 105, the subset of the plurality of user devices 115a-n that correspond to the at least one characteristic associated with the supplemental content item. For example, the content provider(s) 102 may determine, based on viewership information and/or demographic information associated with each of the plurality of user devices 115a-n, the subset of the plurality of user devices 115a-n that correspond to the at least one characteristic associated with the supplemental content item.

The content provider(s) 102 may send data indicative of the initial target audience to the supplemental content provider(s) 112 for storage in at least one database 116 associated with the supplemental content provider(s) 112. Additionally, or alternatively, the content provider(s) 102 may cause storage of data indicative of the initial target audience in the database(s) 105.

The initial target audience associated with the supplemental content item may be determined by the supplemental content provider(s) 112. The content provider(s) 102 may send at least a portion of the data stored in the database(s) 105 to the supplemental content provider(s) 112. The supplemental content provider(s) 112 may receive the data and use the data to determine the initial target audience. For example, the supplemental content provider(s) 112 may determine at least one characteristic associated with the supplemental content item. The at least one characteristic associated with the supplemental content item may indicate a product or service that is being advertised by the supplemental content item. The supplemental content provider(s) 112 may determine, based on the received data, a subset of the plurality of user devices 115a-n that correspond to the at least one characteristic associated with the supplemental content item. For example, the supplemental content provider(s) 112 may determine, based on viewership information and/or demographic information associated with each of the plurality of user devices 115a-n, the subset of the plurality of user devices 115a-n that are most likely to be interested in the supplemental content item.

The supplemental content provider(s) 112 may send data indicative of the initial target audience to the content provider(s) 102 for storage in the database(s) 105. Additionally, or alternatively, the supplemental content provider(s) 112 may cause storage of data indicative of the initial target audience in the database(s) 116.

The content provider(s) 102 may send the supplemental content item along with a first content item in which the supplemental content item is to be inserted to the initial target audience. As described above, the first content item may be determined by the content provider(s) 102 or by the supplemental content provider(s) 112. The first content item may be determined based on at least one characteristic (e.g., attribute) associated with the initial target audience. The at least one characteristic associated with the initial target audience may comprise any quantity of characteristics, such as ten characteristics, twenty characteristics, a hundred characteristics, a thousand characteristics, etc. The at least one characteristic associated with the initial target audience may comprise at least one content viewership characteristic and/or a demographic characteristic associated with the initial target audience. For example, if the initial target audience comprises the subset of the plurality of user devices 115a-n associated with males between the ages of 18-60, the first content item may comprise a television show or movie that is commonly watched by males between the ages of 18-60.

The initial target audience may receive the supplemental content item along with the first content item. The initial target audience may output the supplemental content item during output of the first content item. The initial target audience may output the supplemental content item during one or more supplemental content insertion opportunities in the first content item. By outputting the supplemental content item during output of the first content item, users associated with the initial target audience may be exposed to the supplemental content item.

However, the initial target audience may be too broadly defined. If the initial target audience is too broadly defined, the initial target audience may comprise a significant quantity of user devices 115a-n that are associated with users not actually interested in the supplemental content item. For example, as described above, the initial target audience associated with the supplemental content item may comprise the subset of the plurality of user devices 115a-n associated with males between the ages of 18-60. However, not all males between the ages of 18-60 may actually be interested in viewing the supplemental content item. If the initial target audience comprises a significant quantity of user devices 115a-n that are not actually interested in the supplemental content item, the supplemental content item may be shown to a large quantity of individuals who are not potential customers. Causing output of the supplemental content item to a large quantity of individuals who are not potential customers may be an inefficient use of money and time.

A portion of the initial target audience that interacted with the supplemental content item during output of the first content item may be determined. The portion of the initial target audience that interacted with the supplemental content item during output of the first content item may comprise the user devices from the subset of the plurality of user devices 115a-n that are associated with users that interacted with the supplemental content item during output of the first content item. The users that interacted with the supplemental content item during output of the first content item may comprise one or more users that interacted with the supplemental content item for an amount of time that satisfies a threshold, one or more users that clicked on the supplemental content item, one or more users that purchased at least one of a product or a service associated with the supplemental content item, one or more users that called or messaged a telephone number associated with the supplemental content item, and/or one or more users that visited a web address associated with the supplemental content item.

The portion of the initial target audience that interacted with the supplemental content item during output of the first content item may be determined by the content provider(s) 102 and/or by the third-party provider(s) 132. For example, the third-party provider(s) 132 may determine that at least one user associated with the initial target audience visited a web address associated with the supplemental content item by tracking that the at least one users viewed a particular image and/or pixel on a website associated with the web address. Data indicating the portion of the initial target audience that interacted with the supplemental content item during output of the first content item may be shared with (e.g., sent to) the content provider(s) 102 and/or the supplemental content provider(s) 112.

The initial target audience may be modified (e.g., updated, refined) to generate a modified target audience. The initial target audience may be modified based on the portion of the initial target audience that interacted with the supplemental content item during output of the first content item. The initial target audience may be modified based on at least one characteristic associated with the portion of the initial target audience that interacted with the supplemental content item during output of the first content item. The at least one characteristic associated with the portion of the initial target audience that interacted with the supplemental content item during output of the first content item may indicate viewership information and/or demographic information associated with the portion of the initial target audience that interacted with the supplemental content item during output of the first content item. The at least one characteristic associated with the portion of the initial target audience that interacted with the supplemental content item during output of the first content item may comprise any quantity of characteristics, such as ten characteristics, twenty characteristics, a hundred characteristics, a thousand characteristics, etc.

Modifying the initial target audience based on the at least one characteristic associated with the portion of the initial target audience that interacted with the supplemental content item during output of the first content item may comprise adding at least one user device from the plurality of user devices 115a-n to the initial target audience. The at least one added user devices may be associated with the at least one characteristic associated with the portion of the initial target audience that interacted with the supplemental content item during output of the first content item. The at least one added user devices may not have been included in the initial target audience. Modifying the initial target audience based on the at least one characteristic associated with the portion of the initial target audience that interacted with the supplemental content item during output of the first content item may comprise removing at least one user device from the initial target audience. The at least one removed member may not be associated with the at least one characteristic associated with the portion of the initial target audience that interacted with the supplemental content item during output of the first content item. The modified target audience may comprise a greater percentage of the plurality of user devices 115a-n that are likely to be interested in the supplemental content item than the initial target audience did.

For example, the at least one characteristic associated with the portion of the target audience that interacted with the supplemental content item during output of the first content item may indicate that the portion of the initial target audience that interacted with the supplemental content item during output of the first content item comprises user devices associated with single males between the ages of 18-40. Modifying the initial target audience based on the at least one characteristic may comprise adding at least one user device associated with a single male between the ages of 18-40 to the initial target audience. Modifying the initial target audience based on the at least one characteristic may additionally or alternatively comprise removing at least one user device associated with a user that is not a single male between the ages of 18-40 from the initial target audience. For example, a user device associated with a married male of age 50 and/or a user device associated with a single female of age 30 may be removed from the initial target audience. The modified target audience may comprise a greater percentage of the plurality of user devices 115a-n associated with single males between the ages of 18-40 than the initial target audience did.

Modifying the initial target audience to generate the modified target audience may comprise removing the portion of the initial target audience that interacted with the supplemental content item during output of the first content item. Modifying the initial target audience to generate a modified target audience may comprise removing the portion of the initial target audience that viewed the supplemental content item during output of the first content item, regardless of whether they interacted with the supplemental content item during output of the first content item. Removing the portion of the initial target audience that viewed and/or interacted with the supplemental content item during output of the first content item from the initial target audience may ensure that as many potential customers as possible are exposed to the supplemental content item during the ad campaign.

The initial target audience may be modified by the content provider(s) 102. The content provider(s) 102 may determine the at least one characteristic associated with the portion of the target audience that interacted with the supplemental content item during output of the first content item. The content provider(s) 102 may determine at least one characteristic associated with the portion of the target audience that interacted with the supplemental content item during output of the first content item based on data stored in the database(s) 105. Based on the determined at least one characteristic, the content provider(s) 102 may modify the initial target audience. The content provider(s) 102 may modify the target audience by removing the portion of the initial target audience that viewed and/or interacted with the supplemental content item during output of the first content item.

The content provider(s) 102 may modify the initial target audience using a clustering algorithm and/or any other suitable machine learning algorithm. The clustering algorithm and/or any other suitable machine learning algorithm may be configured to receive, as input, the at least one characteristic associated with the portion of the target audience that interacted with the supplemental content item during output of the first content item. The clustering algorithm and/or any other suitable machine learning algorithm may be configured to determine the modified target audience based on the input. The clustering algorithm and/or any other suitable machine learning algorithm may be configured to output data indicating the modified target audience.

The content provider(s) 102 may send data indicative of the modified target audience to the supplemental content provider(s) 112 for storage in the database(s) 116 associated with the supplemental content provider(s) 112. Additionally, or alternatively, the content provider(s) 102 may cause storage of data indicative of the modified target audience in the database(s) 105.

The initial target audience may be modified by the supplemental content provider(s) 112. The supplemental content provider(s) 112 may determine the at least one characteristic associated with the portion of the target audience that interacted with the supplemental content item during output of the first content item. The content provider(s) 102 may send at least a portion of the data stored in the database(s) 105 to the supplemental content provider(s) 112. The supplemental content provider(s) 112 may receive the data and use the data to determine the at least one characteristic associated with the portion of the target audience that interacted with the supplemental content item during output of the first content item. Based on the determined at least one characteristic, the supplemental content provider(s) 112 may modify the initial target audience. The supplemental content provider(s) 112 may modify the target audience by removing the portion of the initial target audience that viewed and/or interacted with the supplemental content item during output of the first content item.

The supplemental content provider(s) 112 may modify the initial target audience using a clustering algorithm and/or any other suitable machine learning algorithm. The clustering algorithm and/or any other suitable machine learning algorithm may be configured to receive, as input, the at least one characteristic associated with the portion of the target audience that interacted with the supplemental content item during output of the first content item. The clustering algorithm and/or any other suitable machine learning algorithm may be configured to determine the modified target audience based on the input. The clustering algorithm and/or any other suitable machine learning algorithm may be configured to output data indicating the modified target audience.

The supplemental content provider(s) 112 may send data indicating the modified target audience to the content provider(s) 102 for storage in the database(s) 105 associated with the content provider(s) 102. Additionally, or alternatively, the supplemental content provider(s) 112 may cause storage of data indicative of the modified target audience in the database(s) 116.

The content provider(s) 102 may send the supplemental content item along with a second content item in which the supplemental content item is to be inserted to the modified target audience. The second content item may be determined by the content provider(s) 102 or by the supplemental content provider(s) 112. The second content item may be determined based on at least one characteristic associated with the modified target audience. The at least one characteristic associated with the modified target audience may comprise any quantity of characteristics, such as ten characteristics, twenty characteristics, a hundred characteristics, a thousand characteristics, etc. The at least one characteristic associated with the modified target audience may comprise a content viewership characteristic and/or a demographic characteristic associated with the modified target audience. For example, if the modified target audience comprises the subset of the plurality of user devices 115a-n associated with single males between the ages of 18-40, the second content item may comprise a television show or movie that is commonly watched by single males between the ages of 18-40.

The modified target audience may receive the supplemental content item along with the second content item. The modified target audience may output the supplemental content item during output of the second content item. The modified target audience may output the supplemental content item during one or more supplemental content insertion opportunities in the second content item. By outputting the supplemental content item during output of the second content item, the users associated with the modified target audience may be exposed to the supplemental content item.

As described above, the modified target audience may comprise a greater percentage of the plurality of user devices 115a-n that are likely to be interested in the supplemental content item than the initial target audience did. However, the modified target audience may still be too broadly defined. The modified target audience may still comprise a significant quantity of user devices 115a-n that are associated with users not actually interested in the supplemental content item. For example, as described above, the modified target audience associated with the supplemental content item may comprise the subset of the plurality of user devices 115a-n associated with single males between the ages of 18-40. However, not all single males between the ages of 18-40 may actually be interested in viewing the supplemental content item. If the modified target audience comprises a significant quantity of user devices 115a-n that are not actually interested in the supplemental content item, the supplemental content item may be shown to a large quantity of individuals who are not potential customers.

A portion of the modified target audience that interacted with the supplemental content item during output of the second content item may be determined. The portion of the modified target audience that interacted with the supplemental content item during output of the second content item may comprise the user devices from the modified target audience that are associated with users that interacted with the supplemental content item during output of the second content item. The users that interacted with the supplemental content item during output of the second content item may comprise one or more users that interacted with the supplemental content item for an amount of time that satisfies a threshold, one or more users that clicked on the supplemental content item, one or more users that purchased at least one of a product or a service associated with the supplemental content item, one or more users that called or messaged a telephone number associated with the supplemental content item, and/or one or more users that visited a web address associated with the supplemental content item.

The portion of the modified target audience that interacted with the supplemental content item during output of the second content item may be determined by the content provider(s) 102 and/or by the third-party provider(s) 132. For example, the third-party provider(s) 132 may determine that at least one user associated with the modified target audience visited a web address associated with the supplemental content item by tracking that the at least one users viewed a particular image and/or pixel on a website associated with the web address. Data indicating the portion of the modified target audience that interacted with the supplemental content item during output of the second content item may be shared with (e.g., sent to) the content provider(s) 102 and/or the supplemental content provider(s) 112.

The modified target audience may be further modified (e.g., updated, refined) to generate a further modified target audience. The modified target audience may be further modified based on the portion of the modified target audience that interacted with the supplemental content item during output of the second content item. The modified target audience may be modified based on at least one characteristic associated with the portion of the modified target audience that interacted with the supplemental content item during output of the second content item. The at least one characteristic associated with the portion of the modified target audience that interacted with the supplemental content item during output of the second content item may indicate viewership information and/or demographic information associated with the portion of the modified target audience that interacted with the supplemental content item during output of the second content item. The at least one characteristic associated with the portion of the modified target audience that interacted with the supplemental content item during output of the second content item may comprise any quantity of characteristics, such as ten characteristics, twenty characteristics, a hundred characteristics, a thousand characteristics, etc.

Further modifying the modified target audience based on the at least one characteristic associated with the portion of the modified target audience that interacted with the supplemental content item during output of the second content item may comprise adding at least one user device from the plurality of user devices 115a-n to the modified target audience. The at least one added user devices may be associated with the at least one characteristic associated with the portion of the modified target audience that interacted with the supplemental content item during output of the second content item. The at least one added user devices may not have been included in the initial or modified target audience.

Further modifying the modified target audience based on the at least one characteristic associated with the portion of the modified target audience that interacted with the supplemental content item during output of the second content item may comprise removing at least one user device from the modified target audience. The at least one removed member may not be associated with the at least one characteristic associated with the portion of the modified target audience that interacted with the supplemental content item during output of the second content item. The further modified target audience may comprise a greater percentage of user devices that are likely to be interested in the supplemental content item than the modified target audience did.

For example, the at least one characteristic associated with the portion of the target audience that interacted with the supplemental content item during output of the second content item may indicate that the portion of the modified target audience that interacted with the supplemental content item during output of the second content item comprises user devices associated with single males between the ages of 18-30 residing in major metropolitan areas. Further modifying the modified target audience based on the at least one characteristic may comprise adding at least one user device associated with a single male between the ages of 18-30 residing in a major metropolitan area to the modified target audience. Further modifying the modified target audience based on the at least one characteristic may additionally or alternatively comprise removing at least one user device associated with a user that is not a single male between the ages of 18-30 residing in a major metropolitan area from the modified target audience. For example, a user device associated with a single male of age 20 residing in a rural area and/or a user device associated with a single male of age 37 residing in a major metropolitan area may be removed from the modified target audience. The further modified target audience may comprise a greater percentage of user devices associated with single males between the ages of 18-30 residing in major metropolitan areas than the modified target audience did.

Further modifying the modified target audience to generate the further modified target audience may comprise removing the portion of the modified target audience that interacted with the supplemental content item during output of the second content item. Further modifying the modified target audience to generate the modified target audience may comprise removing the portion of the modified target audience that viewed the supplemental content item during output of the second content item, regardless of whether they interacted with the supplemental content item during output of the second content item. Removing the portion of the modified target audience that viewed and/or interacted with the supplemental content item during output of the second content item from the modified target audience may ensure that as many potential customers as possible are exposed to the supplemental content item during the ad campaign.

This process may be repeated any quantity of times. For example, a portion of the further modified audience that interacted with the supplemental content item during output of a third content item may be determined. The further modified audience may be modified again based on at least one characteristic associated with the portion of the further modified audience that interacted with the supplemental content item during output of the third content item. This process may be repeated as many times as possible before the end of the advertising campaign associated with the supplemental content item. Dynamically modifying the target audience for the supplemental content item throughout the course of the advertising campaign may maximize the number of quantity of exposures to the supplemental content item by those individuals most likely to be interested in the supplemental content item—thus maximizing the supplemental content provider's return on advertising investment.

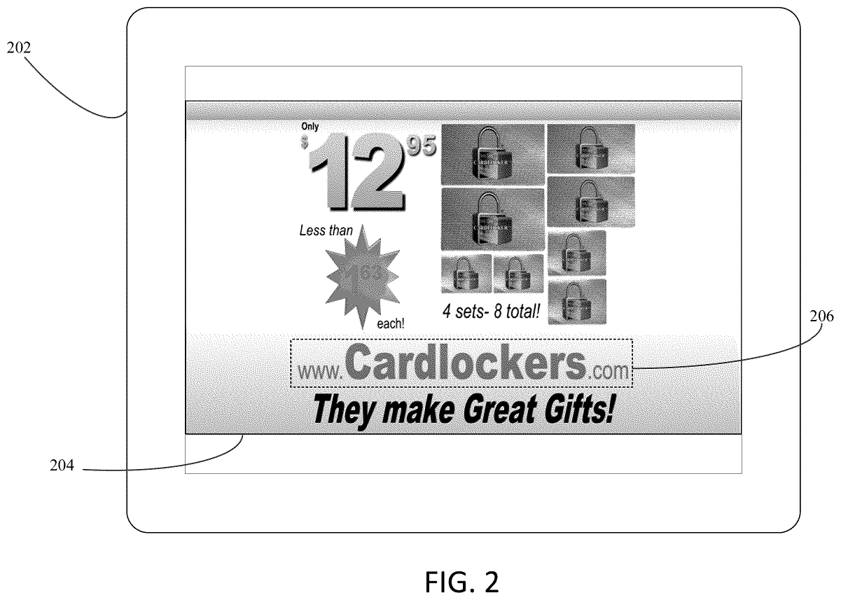

FIG. 2 is an example user device 202. The user device 202 may comprise, for example, a user device from the plurality of user devices 115a-n. The user device 202 may receive a supplemental content item 204 for output. The user device 202 may receive the supplemental content item 204 for output from a content provider (e.g., content provider(s) 102) or from a supplemental content provider (e.g., supplemental content provider(s) 112). The user device 202 may be a member of a target audience associated with the supplemental content item 204.

The user device 202 may cause output of the supplemental content item 204. To cause output of the supplemental content item 204, the user device 202 may display the supplemental content item 204 on an interface or display of the user device 202. The user device 202 may display the supplemental content item 204 on the interface or display of the user device 202 during output of a content item. The content item may be determined based on at least one characteristic of the target audience associated with the supplemental content item 204.

A user associated with the user device 202 may interact with the supplemental content item 204. The supplemental content item 204 may be associated with a product or a service. For example, the supplemental content item 204 may comprise an advertisement for the product or service. The user associated with the user device 202 may interact with the supplemental content item 204 by purchasing or ordering the product or the service. The user may purchase or order the product or the service in any suitable manner, such as via the internet, via telephone, or via email. The user associated with the user device 202 may interact with the supplemental content item 204 by interacting with (e.g., viewing, hovering a mouse over, etc.) the supplemental content item 204 for an amount of time that satisfies a threshold. The user associated with the user device 202 may interact with the supplemental content item 204 by clicking on or selecting the supplemental content item 204.

The supplemental content item 204 may be associated with a web address 206. The web address 206 may be displayed on the interface or display of the user device 202 during output of the supplemental content item 204. The user associated with the user device 202 may interact with the supplemental content item 204 by clicking on a link associated with the web address 206 and/or by visiting a web page associated with the web address 206. The supplemental content item 204 may be associated with a telephone number. The telephone number may be displayed on the interface or display of the user device 202 during output of the supplemental content item 204. The user associated with the user device 202 may interact with the supplemental content item 204 by calling or messaging the telephone number.

The user associated with the user device 202 may interact with the supplemental content item 204 during output of the supplemental content item 204 via the interface or display of the user device 202. The user associated with the user device 202 may interact with the supplemental content item 204 within a time threshold following termination of output of the supplemental content item 204 via the interface or display of the user device 202. For example, the user may interact with the supplemental content item 204 within thirty seconds following termination of output of the supplemental content item 204 via the interface or display of the user device 202.

If a user associated with the user device 202 interacts with the supplemental content item 204, this may indicate that the user associated with the user device 202 is interested in viewing the supplemental content item 204. The target audience associated with the supplemental content item 204 may be modified based on at least one characteristic associated with the user associated with the user device 202. The target audience may be modified so that a greater percentage of the target audience resembles (e.g., shares at least one characteristic with) the user associated with the user device 202. Modifying the target audience so that a greater percentage of the target audience resembles the user associated with the user device 202 may ensure that a greater percentage of the target audience is interested in the supplemental content item 204.

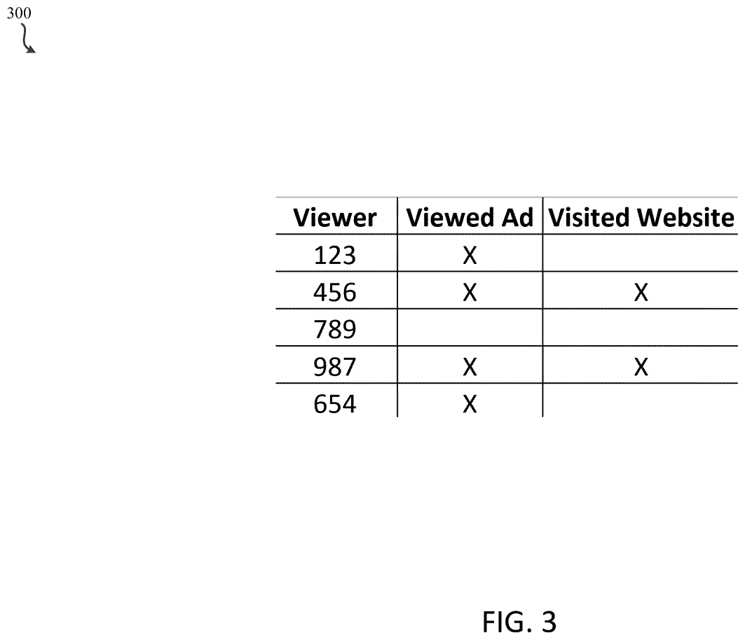

FIG. 3 is example data 300 associated with a target audience. The target audience may be associated with a supplemental content item. The supplemental content item may be associated with a web address. The data 300 indicates which members of the target audience viewed and/or interacted with a supplemental content item during an output of the supplemental content item.

The data 300 is associated with a target audience comprising five members (e.g., user devices, viewers). The first member is represented by the viewer ID 123. The second member is represented by the viewer ID 456. The third member is represented by the viewer ID 789. The fourth member is represented by the viewer ID 987. The fifth member is represented by the viewer ID 654. It should be appreciated that the target audience may comprise any quantity of members in addition to these five members.

The data 300 indicates that each of the five members, except for the third member, viewed the supplemental content item. The data 300 indicates that, out of the four members that viewed the supplemental content item, only two interacted with the supplemental content item. For example, the data 300 indicates that only the second and fourth members interacted with the supplemental content item. The second and fourth members may have interacted with the supplemental content item by visiting a webpage associated with the web address.

As the second and fourth members interacted with the supplemental content item, it may be likely that the second and fourth members of the target audience were interested in viewing the supplemental content item. The target audience associated with the supplemental content item may be modified based on at least one characteristic associated with the second and fourth members of the target audience.

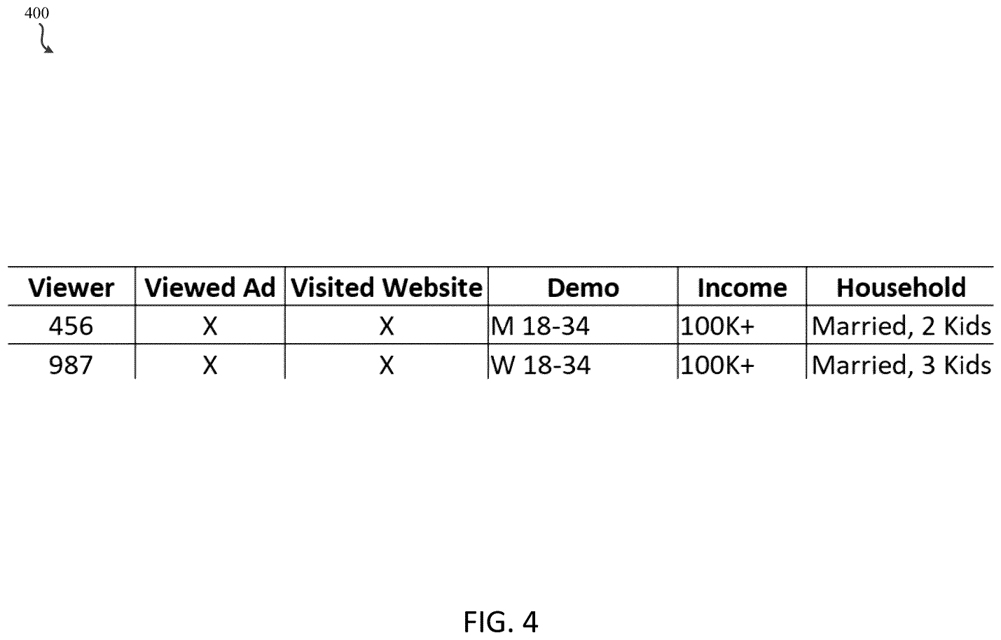

FIG. 4 is example data 400. The data 400 indicates the at least one characteristic associated with the second and fourth members of the target audience. The data 400 indicates that the second member of the target audience (represented by the viewer ID 456) is a male between the ages of 18-34. The data 400 also indicates that the second member of the target audience has an income of $100 k+ and is married with two children. The data 400 indicates that the fourth member of the target audience (represented by the viewer ID 987) is a female between the ages of 18-34. The data 400 also indicates that the fourth member of the target audience has an income of $100 k+ and is married with three children. Thus, it may be determined based on the data 400 that the second and fourth members of the target audience are associated with the following characteristics: between the ages of 18-34, having an income of $100 k+, and married with children.

The target audience associated with the supplemental content item may be modified based on these characteristics. For example, the target audience may be modified so that a greater percentage of the target audience resembles (e.g., shares the at least one characteristic with) the second and fourth members of the target audience. The modified target audience may comprise a greater percentage of members that are between the ages of 18-34, having an income of $100 k+, and married with children.

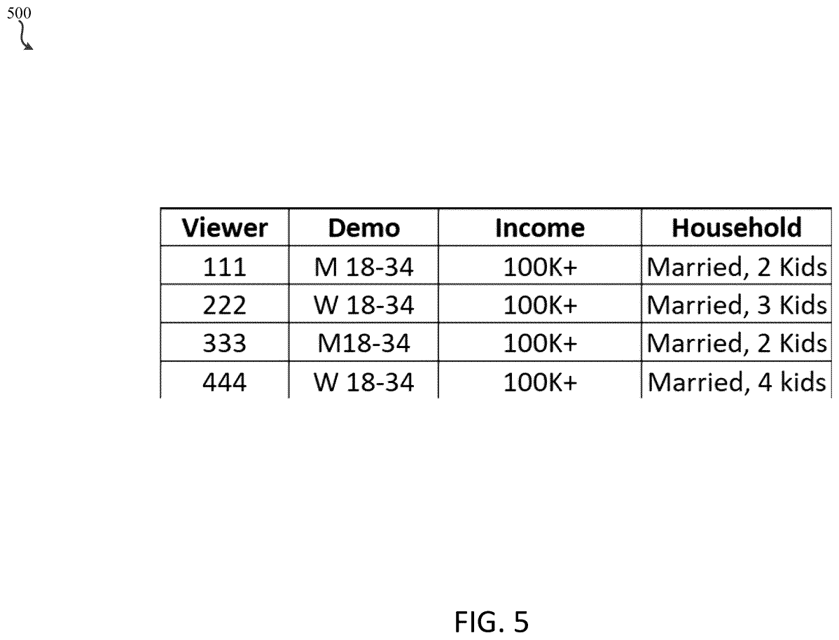

FIG. 5 is example data 500. The data 500 indicates the modified target audience associated with the supplemental content item. The modified target audience comprises four members (e.g., user devices, viewers). The first member is represented by the viewer ID 111. The second member is represented by the viewer ID 222. The third member is represented by the viewer ID 333. The fourth member is represented by the viewer ID 444. It should be appreciated that the modified target audience may comprise any quantity of members in addition to these four members.

The modified target audience may be generated based on the characteristics associated with the second and fourth members of the target audience. Each of the four members of the modified target audience may be associated with at least one of the characteristics associated with the second and fourth members. For example, each of the four members of the modified target audience may be at least one of: between the ages of 18-34, have an income of $100 k+, or be married with children. The modified target audience may comprise a greater percentage of members that are likely to be interested in the supplemental content item. Modifying the target audience may further comprise removing the first and fifth members from the target audience, as the first and fifth members have already viewed the supplemental content item.

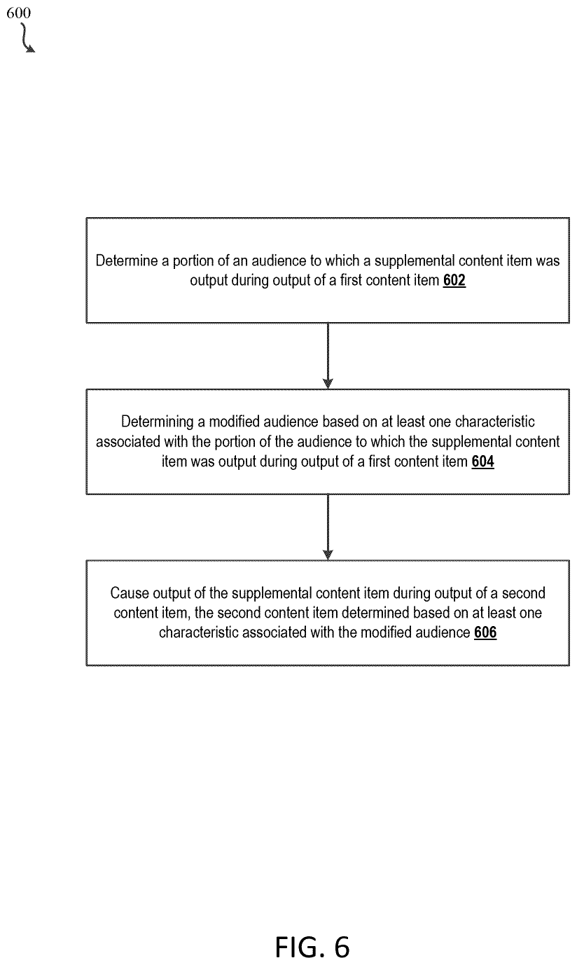

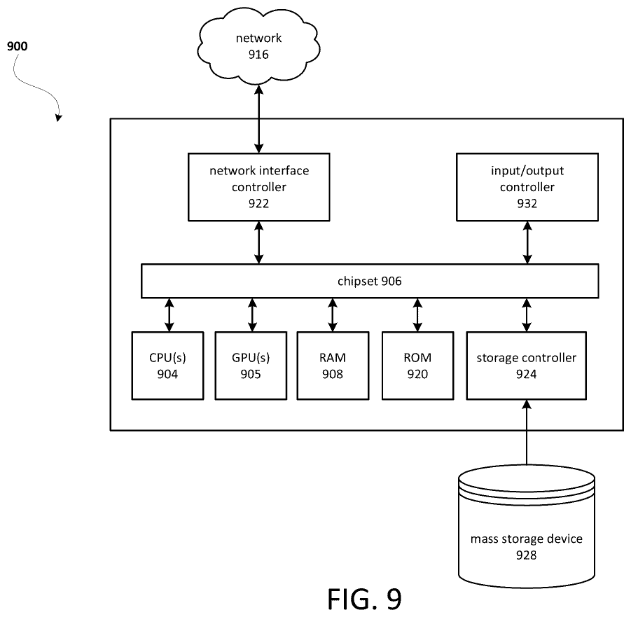

FIG. 6 is an example method 600. The method 600 may comprise a computer implemented method for dynamic modification of an audience. A system and/or computing environment, such as the system 100 of FIG. 1 and/or the computing environment of FIG. 9, may be configured to perform the method 600. For example, one or more of the content provider(s) 102 of FIG. 1 may be configured to perform the method 600.

At 602, a portion of an audience may be determined. The audience may be associated with a supplemental content item. The audience may comprise a target audience (e.g., initial target audience) associated with the supplemental content item. The portion of the audience may comprise a portion of the audience to which the supplemental content item was output during output of a first content item. The portion of the audience may comprise a subset or segment of the audience that interacted with and/or viewed the supplemental content item output during output of the first content item. The portion of the audience that interacted with the supplemental content item during output of the first content item may comprise one or more members of the audience that interacted with the supplemental content item for an amount of time that satisfies a threshold, one or more members of the audience that clicked on the supplemental content item, one or more members of the audience that purchased at least one of a product or a service associated with the supplemental content item, one or more members of the audience that called or messaged a telephone number associated with the supplemental content item, and/or one or more members of the audience that visited a web address associated with the supplemental content item.

The audience may be modified (e.g., updated, refined) to generate a modified audience (e.g., modified target audience). The audience may be modified based on the portion of the audience. The audience may be modified based on at least one characteristic associated with the portion of the audience. At 604, a modified audience may be determined. The modified audience may be determined based on at least one characteristic associated with the portion of the audience. The at least one characteristic associated with the portion of the audience may indicate viewership information and/or demographic information associated with the portion of the audience that interacted with the supplemental content item during output of the first content item. The at least one characteristic associated with the portion of the audience may comprise any quantity of characteristics, such as ten characteristics, twenty characteristics, a hundred characteristics, a thousand characteristics, etc.

Determining the modified audience may comprise adding at least one member to the audience. The at least one added member may be associated with the at least one characteristic. The at least one added member may not have been included in the initial audience. Modifying the audience based on the at least one characteristic may comprise removing at least member from the audience. The at least one removed member may not be associated with the at least one characteristic. The modified audience may comprise a greater percentage of members that are likely to be interested in the supplemental content item.

At 606, output of the supplemental content item may be caused. The output of the supplemental content may be caused during output of a second content item. Causing the output of the supplemental content item during output of the second content item may comprise causing display of the supplemental content item via at least one device associated with the modified audience. The second content item may be determined based on at least one characteristic associated with the modified audience.

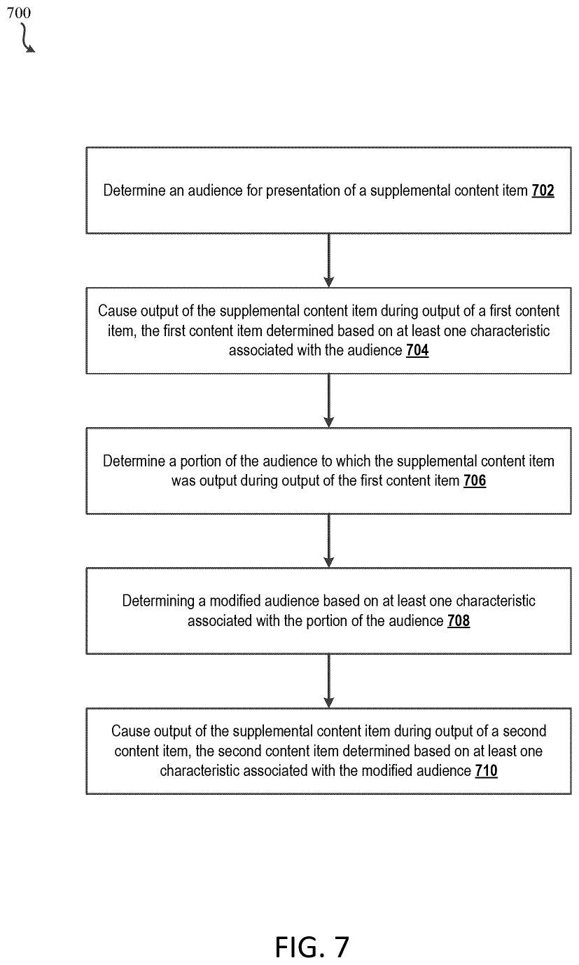

FIG. 7 is an example method 700. The method 700 may comprise a computer implemented method for dynamic modification of an audience. A system and/or computing environment, such as the system 100 of FIG. 1 and/or the computing environment of FIG. 9, may be configured to perform the method 700. For example, one or more of the content provider(s) 102 of FIG. 1 may be configured to perform the method 700.

At 702, an audience for presentation of a supplemental content item may be determined. The audience may comprise a target audience (e.g., initial target audience). The audience may comprise a plurality of user devices. The audience may be associated with members (e.g., viewers) that are most likely to be interested in the supplemental content item. The members that are most likely to be interested in the supplemental content item may comprise users determined to be likely potential customers of the product or service associated with the supplemental content item.

At 704, output of the supplemental content item may be caused. The output of the supplemental content item may be caused during output of a first content item. The first content item may be determined based on at least one characteristic associated with the audience. The at least one characteristic associated with the audience may indicate viewership information and/or demographic information associated with the audience. The at least one characteristic associated with the audience may comprise any quantity of characteristics, such as ten characteristics, twenty characteristics, a hundred characteristics, a thousand characteristics, etc.

At 706, a portion of the audience may be determined. The portion of the audience may comprise a portion of the audience to which the supplemental content item was output during output of the first content item. The portion of the audience may comprise a portion of the audience that viewed and/or interacted with the supplemental content item during output of the first content item. The portion of the audience that interacted with the supplemental content item during output of the first content item may comprise one or more members of the audience that interacted with the supplemental content item for an amount of time that satisfies a threshold, one or more members of the audience that clicked on the supplemental content item, one or more members of the audience that purchased at least one of a product or a service associated with the supplemental content item, one or more members of the audience that called or messaged a telephone number associated with the supplemental content item, and/or one or more members of the audience that visited a web address associated with the supplemental content item.

At 708, a modified audience may be determined. The modified audience may be determined based on at least one characteristic associated with the portion of the audience. The at least one characteristic associated with the portion of the audience may indicate viewership information and/or demographic information associated with the portion of the audience. The at least one characteristic associated with the portion of the audience may comprise any quantity of characteristics, such as ten characteristics, twenty characteristics, a hundred characteristics, a thousand characteristics, etc.

Determining the modified audience based on the at least one characteristic associated with the portion of the audience may comprise adding at least one member to the audience. The at least one added member may be associated with the at least one characteristic. The at least one added member may not have been included in the initial audience. Determining the modified audience based on the at least one characteristic associated with the portion of the audience may comprise removing at least member from the audience. The at least one removed member may not be associated with the at least one characteristic. The modified audience may comprise a greater percentage of members that are likely to be interested in the supplemental content item.

At 710, output of the supplemental content item may be caused. The output of the supplemental content may be caused during output of a second content item. Causing the output of the supplemental content item during output of the second content item may comprise causing display of the supplemental content item via at least one device associated with the modified audience. The second content item may be determined based on at least one characteristic associated with the modified audience.

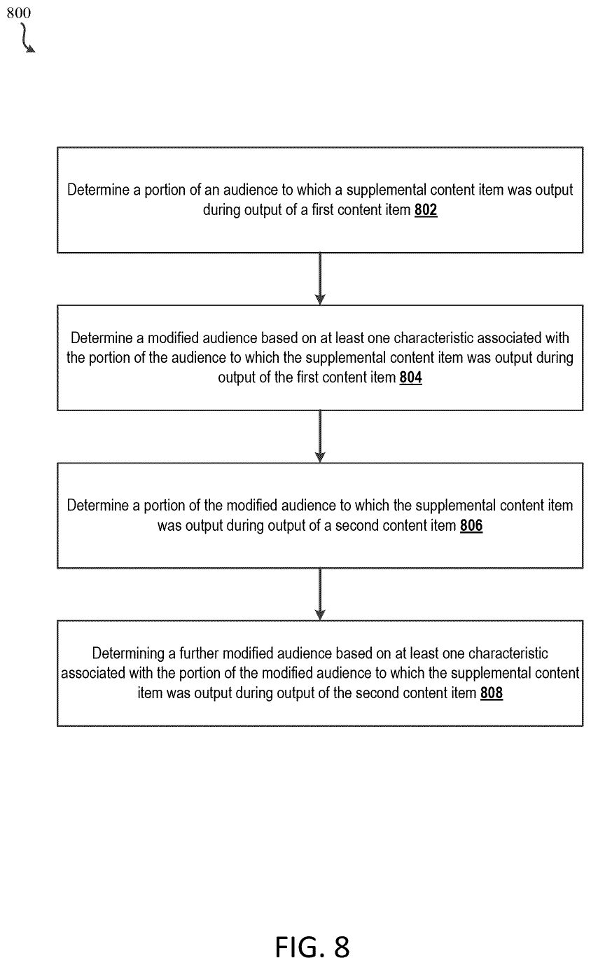

FIG. 8 is an example method 800. The method 800 may comprise a computer implemented method for dynamic modification of an audience. A system and/or computing environment, such as the system 100 of FIG. 1 and/or the computing environment of FIG. 9, may be configured to perform the method 800. For example, one or more of the content provider(s) 102 of FIG. 1 may be configured to perform the method 800.

At 802, a portion of an audience may be determined. The portion of the audience may comprise a portion of an audience to which a supplemental content item was output during output of a first content item. The audience may comprise a target audience. The audience may be associated with a supplemental content item. The portion of the audience may comprise a subset or segment of the audience that interacted with and/or viewed the supplemental content item output during output of a first content item. The portion of the audience that interacted with the supplemental content item during output of the first content item may comprise one or more members of the audience that interacted with the supplemental content item for an amount of time that satisfies a threshold, one or more members of the audience that clicked on the supplemental content item, one or more members of the audience that purchased at least one of a product or a service associated with the supplemental content item, one or more members of the audience that called or messaged a telephone number associated with the supplemental content item, and/or one or more members of the audience that visited a web address associated with the supplemental content item.

The audience may be modified (e.g., updated, refined) to generate a modified audience (e.g., modified target audience). The audience may be modified based on the portion of the audience based on at least one characteristic associated with the portion of the audience to which the supplemental content item was output during output of the first content item. At 804, a modified audience may be determined. The modified audience may be determined based on at least one characteristic associated with the portion of the audience. The at least one characteristic associated with the portion of the audience may indicate viewership information and/or demographic information associated with the portion of the audience. The at least one characteristic associated with the portion of the audience may comprise any quantity of characteristics, such as ten characteristics, twenty characteristics, a hundred characteristics, a thousand characteristics, etc.

Determining the modified audience may comprise adding at least one member to the audience. The at least one added member may be associated with the at least one characteristic. The at least one added member may not have been included in the initial audience. Determining the modified audience may comprise removing at least member from the audience. The at least one removed member may not be associated with the at least one characteristic. The modified audience may comprise a greater percentage of members that are likely to be interested in the supplemental content item.

Output of the supplemental content item may be caused during output of a second content item. Causing the output of the supplemental content item during output of the second content item may comprise causing display of the supplemental content item via at least one device associated with the modified audience. The second content item may be determined based on at least one characteristic associated with the modified audience.

At 806, a portion of the modified audience may be determined. The portion of the modified audience may comprise a portion of the modified audience to which the supplemental content item was output during output of a second content item The portion of the modified audience may comprise a subset or segment of the modified audience that interacted with and/or viewed the supplemental content item output during output of the second content item. The portion of the modified audience that interacted with the supplemental content item during output of the second content item may comprise one or more members of the modified audience that interacted with the supplemental content item for an amount of time that satisfies a threshold, one or more members of the modified audience that clicked on the supplemental content item, one or more members of the modified audience that purchased at least one of a product or a service associated with the supplemental content item, one or more members of the modified audience that called or messaged a telephone number associated with the supplemental content item, and/or one or more members of the modified audience that visited a web address associated with the supplemental content item.

The modified audience may be further modified (e.g., updated, refined) to generate a further modified audience. The modified audience may be further modified based on the portion of the modified audience. The modified audience may be further modified based on at least one characteristic associated with the portion of the modified audience.

At 808, a further modified audience may be determined. The further modified audience may be determined based on at least one characteristic associated with the portion of the modified audience. The at least one characteristic associated with the portion of the modified audience may indicate viewership information and/or demographic information associated with the portion of the modified audience. The at least one characteristic associated with the portion of the modified audience may comprise any quantity of characteristics, such as ten characteristics, twenty characteristics, a hundred characteristics, a thousand characteristics, etc.

Further modifying the modified audience based on the at least one characteristic associated with the portion of the modified audience may comprise adding at least one member to the modified audience. The at least one added member may be associated with the at least one characteristic. The at least one added member may not have been included in the modified audience. Further modifying the modified audience based on the at least one characteristic associated with the portion of the modified audience may comprise removing at least member from the modified audience. The at least one removed member may not be associated with the at least one characteristic. The further modified audience may comprise a greater percentage of members that are likely to be interested in the supplemental content item.

FIG. 9 is an example computing device 900 that may represent any of the various devices or entities of FIG. 1, including, for example, the content provider(s) 102, the supplemental content provider(s) 112, the third-party provider(s) 132, or the plurality of user devices 115a-n. That is, the computing device 900 in FIG. 9 may be any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 6-8.

The computing device 900 may include a baseboard, or “motherboard,” which is a printed circuit board to which a multitude of components or devices may be connected by way of a system bus or other electrical communication paths. One or more central processing units (CPUs or “processors”) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 904 may be augmented with or replaced by other processing units, such as GPU(s) 905. The GPU(s) 905 may comprise processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random-access memory (RAM) 908 used as the main memory in the computing device 900. The chipset 906 may provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 900 in accordance with the aspects described herein.

The computing device 900 may operate in a networked environment using logical connections to remote computing nodes and computer systems of the system 90. The chipset 906 may include functionality for providing network connectivity through a network interface controller (NIC) 922. A NIC 922 may be capable of connecting the computing device 900 to other computing nodes over the system 90. It should be appreciated that multiple NICs 922 may be present in the computing device 900, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the system 90. For example, the NIC 922 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 900 may be connected to a mass storage device 928 that provides non-volatile storage (i.e., memory) for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 928 is characterized as primary or secondary storage and the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may read information from the mass storage device 928 by detecting the physical states or characteristics of one or more particular locations within the physical storage units.

In addition to the mass storage device 928 described herein, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 928 depicted in FIG. 9, may store an operating system utilized to control the operation of the computing device 900. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described herein. The computing device 900 may have access to computer-readable storage media storing computer-executable instructions, which, when executed by the computing device 900, may perform the methods described in relation to FIGS. 8-9.

A computing device, such as the computing device 900 depicted in FIG. 9, may also include an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not include all of the components in FIG. 9, may include other components that are not explicitly shown in FIG. 9, or may utilize an architecture completely different than that shown in FIG. 9.

As described herein, a computing device may be a physical computing device, such as the computing device 900 of FIG. 9. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes-from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
determining a portion of an audience to which a supplemental content item was output during output of a first content item;
determining a modified audience based on at least one characteristic associated with the portion of the audience to which the supplemental content item was output during output of the first content item; and
causing output of the supplemental content item during output of a second content item, wherein the second content item is determined based on at least one characteristic associated with the modified audience.

2. The method of claim 1, wherein the modified audience comprises a modified target audience, and wherein determining the modified audience comprises modifying an initial target audience associated with the supplemental content item.

3. The method of claim 1, wherein the portion of the audience to which the supplemental content item was output during output of the first content item comprises at least one of:
at least one member of the audience that interacted with the supplemental content item;
at least one member of the audience that interacted with the supplemental content item for an amount of time that satisfies a threshold;
at least one member of the audience that viewed the supplemental content item;
at least one member of the audience that clicked on the supplemental content item;
at least one member of the audience that purchased at least one of a product or a service associated with the supplemental content item;
at least one member of the audience that called or messaged a telephone number associated with the supplemental content item; or
at least one member of the audience that visited a web address associated with the supplemental content item.

4. The method of claim 1, wherein determining the modified audience based on at least one characteristic associated with the portion of the audience to which the supplemental content item was output during output of the first content item comprises at least one of:
adding at least one member to the audience, wherein the at least one added member is associated with the at least one characteristic associated with the portion of the audience to which the supplemental content item was output during output of the first content item; or
removing at least one member from the audience, wherein the at least one removed member is not associated with the at least one characteristic associated with the portion of the audience to which the supplemental content item was output during output of the first content item.

5. The method of claim 1, wherein the modified audience does not comprise the portion of the audience to which the supplemental content item was output during output of the first content item.

6. The method of claim 1, wherein causing the output of the supplemental content item during output of the second content item comprises causing display of the supplemental content item via at least one device associated with the modified audience.

7. The method of claim 1, wherein at least one characteristic associated with the portion of the audience to which the supplemental content item was output during output of the first content item and the at least one characteristic associated with the modified audience each comprise at least one of age, gender, occupation, years of home ownership, household size, income, geographic location, family size, or media consumption habits.

8. The method of claim 1, wherein the supplemental content item comprises an advertisement.

9. A method comprising:
determine an audience for presentation of a supplemental content item;
causing output of the supplemental content item during output of a first content item, wherein the first content item is determined based on at least one characteristic associated with the audience;
determining a portion of the audience to which the supplemental content item was output during output of the first content item;
determining a modified audience based on at least one characteristic associated with the portion of the audience to which the supplemental content item was output during output of the first content item; and
causing output of the supplemental content item during output of a second content item, wherein the second content item is determined based on at least one characteristic associated with the modified audience.

10. The method of claim 9, wherein the portion of the audience to which the supplemental content item was output during output of the first content item comprises at least one of:
at least one member of the audience that interacted with the supplemental content item;
at least one member of the audience that interacted with the supplemental content item for an amount of time that satisfies a threshold;
at least one member of the audience that viewed the supplemental content item;
at least one member of the audience that clicked on the supplemental content item;
at least one member of the audience that purchased at least one of a product or a service associated with the supplemental content item;
at least one member of the audience that called or messaged a telephone number associated with the supplemental content item; or
at least one member of the audience that visited a web address associated with the supplemental content item.

11. The method of claim 9, wherein determining the modified audience based on the at least one characteristic associated with the portion of the audience to which the supplemental content item was output during output of the first content item comprises at least one of:
adding at least one member to the audience, wherein the at least one added member is associated with the at least one characteristic associated with the portion of the audience to which the supplemental content item was output during output of the first content item; or
removing at least one member from the audience, wherein the at least one removed member is not associated with the at least one characteristic associated with the portion of the audience to which the supplemental content item was output during output of the first content item.

12. The method of claim 9, wherein the modified audience does not comprise the portion of the audience to which the supplemental content item was output during output of the first content item.

13. The method of claim 9, wherein causing output of the supplemental content item during output of the first content item comprises causing display of the supplemental content item via at least one device associated with the audience, and wherein causing output of the supplemental content item during output of the second content item comprises causing display of the supplemental content item via at least one device associated with the modified audience.

14. The method of claim 9, wherein the supplemental content item comprises an advertisement.

15. A method comprising:
determining a portion of an audience to which a supplemental content item was output during output of a first content item;
determining a modified audience based on at least one characteristic associated with the portion of the audience to which the supplemental content item was output during output of the first content item;
determining a portion of the modified audience to which the supplemental content item was output during output of a second content item; and
determining a further modified audience based on at least one characteristic associated with the portion of the modified audience to which the supplemental content item was output during output of the second content item.

16. The method of claim 15, further comprising causing output of the supplemental content item during output of a third content item, wherein the third content item is determined based on at least one characteristic associated with the further modified audience.

17. The method of claim 15, wherein the modified audience does not comprise the portion of the audience to which the supplemental content item was output during output of the first content item, and wherein the further modified audience does not comprise the portion of the modified audience to which the supplemental content item was output during output of the second content item.

18. The method of claim 15, wherein the portion of the audience to which the supplemental content item was output during output of the first content item comprises at least one of:
at least one member of the audience that interacted with the supplemental content item;
at least one member of the audience that interacted with the supplemental content item for an amount of time that satisfies a threshold;
at least one member of the audience that viewed the supplemental content item;
at least one member of the audience that clicked on the supplemental content item;
at least one member of the audience that purchased at least one of a product or a service associated with the supplemental content item;
at least one member of the audience that called or messaged a telephone number associated with the supplemental content item; or
at least one member of the audience that visited a web address associated with the supplemental content item.

19. The method of claim 15, wherein the portion of the modified audience to which the supplemental content item was output during output of the second content item comprises at least one of:
at least one member of the modified audience that interacted with the supplemental content item;
at least one member of the modified audience that interacted with the supplemental content item for an amount of time that satisfies a threshold;
at least one member of the modified audience that viewed the supplemental content item;
at least one member of the modified audience that clicked on the supplemental content item;
at least one member of the modified audience that purchased at least one of a product or a service associated with the supplemental content item;
at least one member of the modified audience that called or messaged a telephone number associated with the supplemental content item; or
at least one member of the modified audience that visited a web address associated with the supplemental content item.

20. The method of claim 15, wherein the at least one characteristic associated with the portion of the audience to which the supplemental content item was output during output of the first content item and the at least one characteristic associated with the portion of the modified audience to which the supplemental content item was output during output of the second content item each comprise at least one of age, gender, occupation, years of home ownership, household size, income, geographic location, family size, or media consumption habits.
